(19) United States
(12) Patent Application Publication
(10) Pub. No.: US 2003/0028442 A1
(43) Pub. Date: Feb. 6, 2003

(54) Method of supplying heart screening services directly to a customer

(76) Inventors: Craig Wagstaff, Carlsbad, CA (US); Judith C. Lenane, Lake Bluff, IL (US); M. Alan Brewer, San Diego, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/924,361

(22) Filed: Aug. 6, 2001

(51) Int. Cl. G06F 17/60

(52) U.S. Cl. 705/26

(57) ABSTRACT

A method of supplying medical screening services directly to a customer includes the steps of customer enrollment, electronic data collection and data transfer by the customer, data assessment by a screening service, and providing a report to the customer by the screening service. The report is made directly available to the customer by fax, by mail, by electronic mail, or by the Internet. Should a life threatening event be indicated by the assessment of the customer's data, the screening center will request emergency medical care for the customer. A recording device is sold to the customer either through telemarketing, direct mail, catalog sales, television, or retail outlets. The screening center has a cardiologist available to review the customer's ECG data upon the referral by a registered nurse.

### BACKGROUND

The invention relates generally to personal health screening, particularly by customers who have been diagnosed with heart problems, those who feel they are at risk for heart problems, or those who are health conscious and want to be aware of their heart's condition. More particularly, the invention relates to a lower cost method of doing business that includes electronic data collection by the customer, providing the data to health care professionals for assessment and screening, providing an assessment report to the customer, and notifying a physician and, if necessary, emergency medical personnel if the data indicate a clinically significant situation.

The development of electronic technology has facilitated an individual's ability to assess important aspects of his or her own health without the cost or time required by physician involvement. For example, individuals have been able to assess their own blood pressure and pulse with self-inflating arm cuffs and digital readouts. Such devices have been available for the better part of two decades. Unlike the traditional method of using a stethoscope and a sphygmomanometer, the presence of a physician is not required with these newer devices. A person only needs to understand the significance of his blood pressure numbers, without knowing how those numbers are determined or knowing what to listen for through the stethoscope. Similar advances in electronic technology have enabled individuals to determine their own blood oxygen level, sugar level, and other aspects of their own health parameters.

With the advent of more and better communications, people have also developed a better understanding of health issues and information related to health. Individuals are more sophisticated in their knowledge and in their demand for products and services that will provide more health-related information about themselves than they have had in the past. This phenomenon applies to people who are healthy as well as those who are ill. Both want to screen the status of their own health. Also, increasingly complex medical care requires that individuals actively participate in screening their health without spending the time and incurring the cost of physician involvement. Furthermore, despite continuing technological developments and increasing medical sophistication among consumers, there is still a need to lower the costs of medical devices and services.

Recently, additional developments have greatly improved remote medical assessment, in particular, that of the heart function. An individual, without the assistance of a physician, can easily operate trans-telephonic recorders, such as those sold by Instromedix (Card Guard Technologies). These electronic devices record data about an individual's heart rhythm and transfer that data to a remote facility for analysis. One such device is the Instromedix (Card Guard Technologies) HeartCard® trans-telephonic recorder, commonly referred to as a post-symptom cardiac event recorder. This particular cardiac event recorder is approximately the size of a credit card, weighs approximately one ounce, and can be carried by a patient and operated from virtually anywhere that a telephone can be found. It records electrocardiograph (“ECG”) rhythm strip readings from sensors placed against the patient's chest for a approximately one minute. After each recording or when the recorder has reached its recording capacity, the patient calls his doctor's office or a professional screening service, and transmits the recorded ECG signals.

One such health screening service that efficiently works with the Instromedix (Card Guard Technologies) HeartCard® cardiac event recorder is LifeWatch of Buffalo Grove, Ill. LifeWatch provides such trans-telephonic cardiac screening services and has a receiving center staffed by registered cardiac nurses, and certified technicians, and board certified cardiologists. Through different trans-telephonic devices, individuals have provided ECG data from event recorders. That data has been processed and assessed at the LifeWatch receiving center, which is staffed twenty-four hours a day, seven days a week.

LifeWatch currently provides its services to physicians, but not directly to individuals. Physicians are required to prescribe the LifeWatch service to their patients for a thirty-day period. Then, LifeWatch sends a recording device to the physician's patient for use with the LifeWatch service. LifeWatch retains ownership of the recording device, and requires its return at the termination of screening services. LifeWatch prepares a report based on the analysis of the patient's transmitted ECG rhythm strip signals and provides the report to the patient's prescribing physician, but not to the patient. Typically, payments are made by insurance or Medicare to LifeWatch.

Individuals now want more involvement in the maintenance of their health, both for peace of mind and for feedback when the individual has had a history of cardiac related events, such as myocardial infarction, coronary bypass surgery, percutaneous transluminal coronary angioplasty, arrhythmia, fainting, premature ventricular contractions, skipped beats, or palpitations. Many want to procure such health assessment even if a physician has not prescribed such. At the same time, they would prefer that the cost of such increased assessment be kept to a reasonable level.

Hence, a need has been recognized by those skilled in the art for an individual to have more control over the maintenance of knowledge about his or her health. A further need has been recognized for the provision of lower cost health screening services in which there is limited physician involvement. Yet a further need has been identified in that individuals would prefer to have access to a report from a health professional as soon as possible, written in terms that an individual can readily understand. A further need has been recognized for the provision of such health screening services directly to an individual without the need for a prescription from a physician, where the individual can directly receive the results of the screening service. The invention fulfills these needs and others.

### SUMMARY OF THE INVENTION

Briefly and in general terms, the present invention is directed to a method of supplying medical screening services directly to a customer. In a broad aspect, the method includes four basic steps:

1) providing a recording device to a customer;

2) customer enrollment in a screening plan;

3) data collection by the customer of his medical data, transfer of the collected data to a screening center, and assessment of that received data by the screening center; and

4) making a report directly available to the customer by the screening center.

In more detailed aspects of the invention, there is provided a method of providing a lower-cost medical screening service to a customer, comprising arranging to make available a medical recording device to a customer, the recording device collecting electronic medical data about the customer, arranging to provide the customer a screening service that provides assessment of the electronic medical data collected from the customer by the recording device, receiving at a remote screening center the electronic medical data of the customer collected by the medical recording device, the data having been electronically transferred to the screening center for assessment, assessing the medical data of the customer at the screening center and producing a customer assessment report representative of the assessment results of the medical data of the customer, and making available the customer assessment report directly to the customer.

In more detailed aspects, the step of making available a medical recording device comprises selling the recording device to the customer through a direct-mail arrangement. Alternately, the step of making available a medical recording device comprises selling the recording device to the customer through a telemarketing arrangement, or through other commercial outlets such as catalogs or the Internet. One significant feature of the present invention is that the medical recording device is actually owned by the customer. Further, the step of assessing the medical data of the customer at the screening center and producing assessment results comprises the step of assessing the data by trained medical personnel other than a doctor that the customer has directly engaged.

In yet further aspects in accordance with the invention, the step of arranging to provide the customer a screening service comprises the step of charging the customer a fee, the amount of which is based on the level of service selected by the customer. The step of charging the customer a fee comprises the step of basing the fee amount on the number of times electronic medical data collected by the customer's medical recording device is received at a remote screening center for assessment. Other price options are also applicable, including a scenario where the device and service are priced as a package, effectively lowering the initial cost of the recording device to the customer.

The step of making available the customer assessment report directly to the customer comprises the steps of sending the report to the customer via electronic facsimile transmission, sending the report to the customer through a mail or courier delivery service, or posting the report on an Internet-accessible computer to which the customer has access via the Internet and which is adapted for printing or viewing by the customer. Further, the step of posting the report on an Internet-accessible computer to which the customer has access via the Internet comprises posting the report so that the customer can print or download a copy of the report. The report may also be sent to the customer via electronic mail. Other methods of making the report available to the customer can be envisioned. For instance, cellular telephone communications may be used, “blue tooth” technology may be incorporated, and other approaches.

In more detailed aspects of the method in accordance with the invention, the step of arranging to make available a medical recording device comprises making available a heart recording device that records the customer's ECG and that is adapted to transmit the recorded ECG data to the screening center. The ECG recording device may be portable and may comprise multiple electrodes or lead wires for application to the customer. The recording capacity of the device is selected so that there is enough recording time to make an assessment of the customer's cardiac function. The step of making available a portable device that records the customer's ECG data comprises making available a portable recording device that is adapted to transmit the recorded data over a telephone line, wide area networks, cellular phone systems, Internet communication protocols, local area networks, or combination of these and/or other communications technologies. The data may also be transmitted via proprietary or encrypted protocols.

In even further aspects, the step of assessing the medical data of the customer at the screening center comprises assessing the data by a cardiac technician and a registered cardiac nurse who have been retained by the screening center to assess customer data who have not been retained directly by the customer. The step of assessing the medical data by a cardiac technician and a registered cardiac nurse comprises the step of assessing ECG data from the customer by a cardiac technician and a registered cardiac nurse.

In even further aspects, the step of assessing the medical data of the customer at the screening center comprises assessing the data by a doctor who has been retained by the screening center to assess customer data as selected by the screening center and who has not been retained directly by the customer. The step of assessing the medical data by a doctor comprises the step of assessing ECG data from the customer by a cardiologist. And in another aspect, the method further comprises the step of charging the customer a fee for the screening services, the amount of which remains the same even if a physician assesses the customer's ECG data.

Further aspects include contacting the customer's physician or requesting emergency medical care for the customer if the step of assessing the medical data of the customer at the screening center indicates that the customer is experiencing a clinically significant event. The agreement by a personal doctor of the customer under which the personal doctor agrees to furnish the screening center with a telephone number of the personal doctor's practice and the personal doctor of the customer agrees to take telephone calls from the screening service may also be obtained.

In yet more aspects in accordance with the invention, there is provided a method of providing a heart screening service to a customer comprising making available for direct sale to a customer an electronic, recording device, the recording device collecting electronic ECG data about the customer, arranging to provide the customer a screening service that provides a fee-for-service assessment of the electronic ECG data collected by the recording device, receiving at a remote screening center the electronic ECG data of the customer collected by the recording device, the data having been electronically transferred by the customer to the screening center for assessment, assessing the ECG data of the customer at the screening center and producing assessment results without the assessment of the customer's ECG data by a personal doctor of the customer, creating a customer assessment report at the screening center representative of the assessment results of the ECG data of the customer, and making available the customer assessment report directly to the customer.

Other aspects and advantages of the invention will become apparent from the following detailed description, taken in conjunction with the accompanying drawings, which illustrate, by way of example, principles of the invention.

### BRIEF DESCRIPTION OF THE DRAWINGS

FIG. 1 is a flowchart depicting the general outline of a heart screening method in accordance with aspects of the invention;

FIG. 2 is also a flowchart of the steps in an enrollment process usable in accordance with the screening method shown in FIG. 1;

FIG. 3 is a flowchart of the screening center's activities in assessing the customer's information and in providing a report, also in accordance with aspects of the invention;

FIG. 4 presents a sample report that can be furnished to a customer after an ECG transmission has been received and assessed, depending on the results of that assessment; and

FIG. 5 presents a sample report that can be furnished to the doctor of the customer and contains the ECG data recorded by the customer in a strip chart format for review by the doctor.

### DETAILED DESCRIPTION OF THE PREFERRED EMBODIMENTS

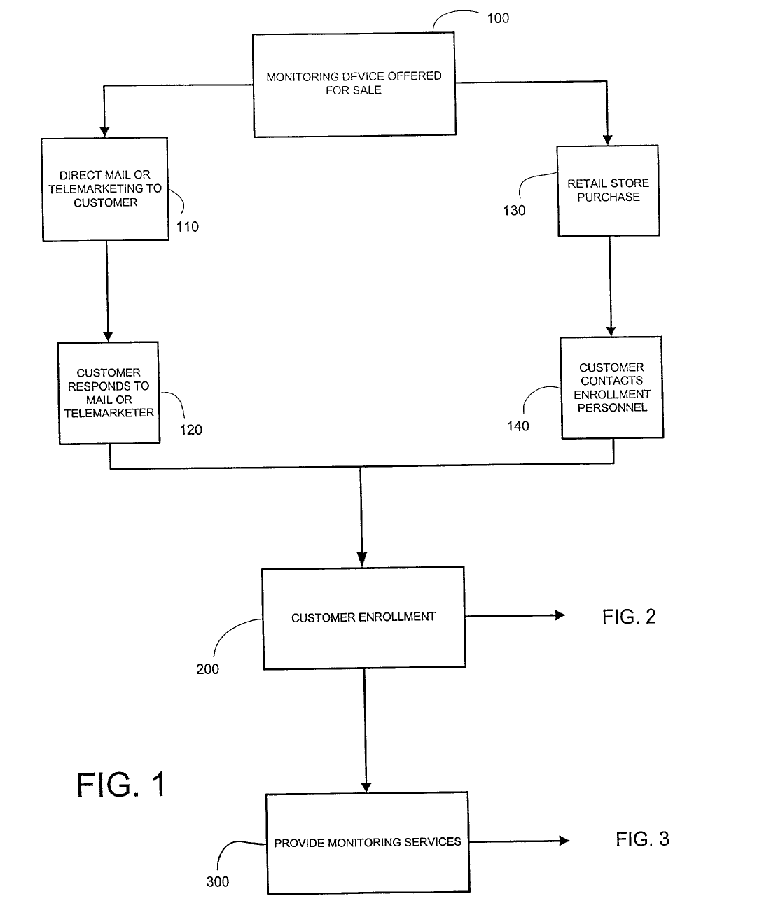

Referring now to the drawings in which like reference numerals indicate like or corresponding elements among the figures, there is shown in FIG. 1 a method for providing heart screening services directly to a customer. The three stages as depicted in the drawings include providing a recording device to a customer 100, customer enrollment in a screening service plan 200, and providing the screening service to the customer 300.

FIG. 1 also depicts in more detail how the recording device is provided to the customer. In the embodiment shown, the device is sold to and owned by the customer. A small, portable recording device is offered for sale either by direct mail and telemarketing 110 to the customer to which the customer responds 120. The device may also, or alternatively, be offered to customers by sales in catalogs, via the Internet, on television, or through retail stores 130. Other approaches to attract the attention of customers may also be used.

The recording device in this embodiment is a small, trans-telephonic, electrocardiograph recorder/transmitter, referred to as a cardiac event recorder, such as those distributed by Instromedix (Card Guard Technologies), or a comparable device. In a preferred embodiment, the cardiac event recorder is capable of storing one thirty-second ECG. A customer who wishes to have his heart function screened activates the device. The screening may be performed either on a regular basis, or when a customer experiences transient symptoms. The device is placed directly on the chest or (less commonly) uses a two-wire lead set connected to electrodes attached to the customer's body. The recording device records thirty seconds of ECG once the customer has pushed the RECORD button. One segment of ECG may be stored and then transmitted later. The transmission takes the form of FM acoustic tones. The cardiac event recorder is held next to the mouthpiece of a telephone, and the SEND button is depressed. The cardiac event recorder then sends the signals audibly over the telephone. Other electronic cardiac event recorders, with different transmission and reception features, may also be used, including devices that use cellular transmission, the Internet, modems, wide area networks, proprietary data transmission methods, or any combination thereof, or through use of other communication means.

As noted, the recording device can be sold in several different ways. If it is to be sold through a retail store 130, the device will first be sold or consigned to the retail outlet by the device's manufacturer or an affiliate. The customer then purchases the device from a retail store 130. The package containing the device will include material about the proper use, storage and handling of the recorder, and about enrollment in a screening service which the customer will review 140. That screening service is physically remote from the customer, but does not require customer travel. In the case of a preferred cardiac event recorder, signals are sent trans-telephonically. Other devices may transmit differently, as noted above. At the screening center, the ECG information is assessed, and a report is produced and provided to the customer by Internet, facsimile, electronic mail or traditional mail, or courier service.

The initial enrollment 200 of the customer requires a signed Agreement to Participate form that is included with the recording device package. The Agreement to Participate form is intended to demonstrate that the customer understands the general nature of the service. For example, the enclosed form(s) can include a requirement that the customer contact his physician to verify in writing that the physician is willing to be contacted in cases where the customer's screening demonstrates clinically significant events. The agreement can also include terms conditioning enrollment of the customer upon receipt of a written verification from the physician within a fixed period of time, such as thirty-five days. Should the verification not be received within thirty-five days, the customer's enrollment is canceled or service is modified in some way. The agreement can also include disclaimers from the screening service, in which the customer acknowledges that the screening service cannot predict a heart attack or other medical conditions and that it is not a substitute for physician care and that it is only a screening service. The agreement can also include a more detailed description of the screening services, as described below. Other terms in the Agreement to Participate form may also be important. For example, if the cardiac event recorder that is sold is sensitive to signals emitted by pacemakers and defibrillators or other medical devices implanted or otherwise used by the customer, customers with those devices cannot use the cardiac event recorder heart screening device. Therefore, in such an instance, the Agreement to Participate form would include a statement by the customer that he or she does not have a defibrillator or pacemaker, or other such device.

Various aspects of the enrollment process may be sequenced in different ways. In one example, the customer may not be permitted to begin using the service until all materials have been received by the screening service, such as the Agreement to Participate and the customer's physician's agreement. Alternatively, the customer may begin to use the service immediately after purchasing the recording device and speaking to a representative of the screening service provider, or after sending in the Agreement to Participate to the screening service, with the proviso that the screening service is automatically canceled if all materials are not received by the screening service within a specified time, e.g. thirty-five days.

In cases where the customer has a history of serious cardiac problems, enrollment by the customer may be conditioned on the customer first consulting a physician. Such serious problems could include coronary artery blockage, heart valve problems, congestive heart failure, or a heart transplant.

When the customer purchases the heart recording device from a retail store 130 and reviews the enrollment material, he may have questions. Therefore, it is anticipated he may call a telephone number provided in the enrollment material 140 to obtain information and ask questions about both the recording device and the screening services.

An alternative to sale of the recording device through a retail outlet is sale of the device through direct mail or telemarketing, catalog sales, television, radio, Internet sites, or other sales channels.

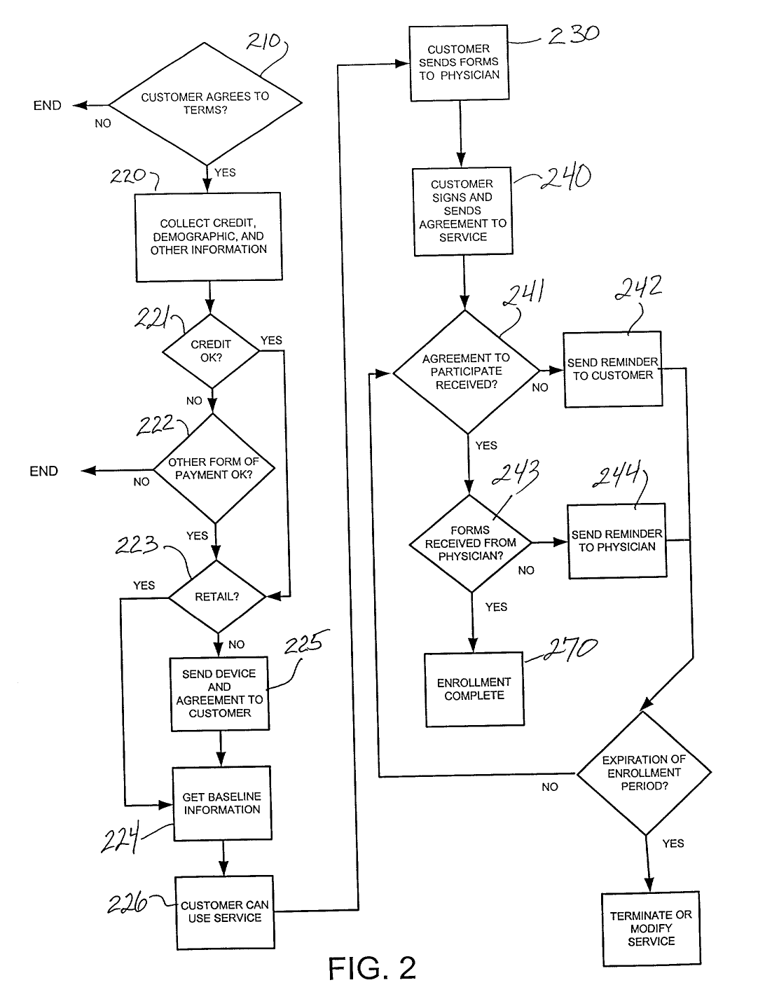

Once the customer orally agrees to participate, or the retail customer returns his Agreement to Participate, the parties then move to the enrollment process 200, an embodiment of which is depicted in FIG. 2. After agreeing to participate, either with a telemarketer or by mailing in an Agreement to Participate form 120, or by other means, the customer and the entity selling the screening service can discuss additional aspects of the screening service. For example, the screening service may provide a variety of service packages. The customer can agree to a fixed monthly fee, for which he receives a set number of screenings. Some volume discount may be provided to customers who enroll in a screening service package allowing for a greater number of screenings per period of time. Alternatively, a customer may simply want to enroll at a single unit price. That single unit price would likely be higher than the per unit price of multiple screenings, because the service provider would have no guarantee of a definite income stream from the customer. Also the pricing of the recorder and the pricing of the service may be hybridized or combined, where the pricing of one subsidizes the other. One such example is when the price of the device is set artificially low to encourage customers who will not pay a higher price for the recorder, and the service is priced accordingly higher.

The customer's selection of such various packages of screening services may depend upon financial constraints, input to the customer from his physician, as well as the nature of the customer's ailment. Some customers, for example, might only want to have an ECG assessment provided after they have experienced and perceived a physical event, such as pain, palpitations, or arrhythmia.

Once the customer has agreed on all of the terms 210, the customer then provides credit, demographic, health, and other information 220. That information can be provided to the entity selling the screening services, such as the telemarketer, or directly to the entity that will assess heart screening data provided by the customer. The process can, however, be modified. For example, additional medical information may be provided to the screening service by the customer's physician at a later time. Among the information that is provided by the customer is information relating to the customer's credit. Arrangements for payment can vary. For example, the customer's monthly bill can be put directly on a credit card, or a monthly invoice can be sent to the customer, for payment by check or credit card.

The customer's credit is checked 221, or if credit is not available, arrangements may be offered for some other form of payment, such as by money order, cashier's check, or other 222. If no payment terms are acceptable, service is not offered. If payment can be arranged with the customer, the type of customer approach is considered. If the customer was attracted through retail sales 223, he already has the cardiac event recorder and he will be authorized to furnish his baseline information 224, as will be discussed below in more detail. The device kit purchased by the customer in retail sales will include the Agreement to Participate form, which must then be executed. The recording device kit will also have the forms to send to the physician. The package with the recording kit will likely include other pertinent material, such as an owner's manual, carrying case, instructional videotape, short reference guide, and other agreements related to medical, personal, or credit information.

If the customer has purchased the recording device through telemarketing or direct mail or similar sales channels, he must first be sent the device kit, including the Agreement to Participate form, which must then be executed 225. The recording device kit will also have the forms to send to the physician and the other pertinent materials, such as an owner's manual, carrying case, instructional videotape, short reference guide, and other agreements related to medical, personal, or credit information.

Once those items have been received, that customer can then proceed with contacting the service center to provide his baseline information, discussed below. Both types of customers can also begin using the heart screening services 226. The customer also then sends the necessary forms for his physician to complete 230. The customer will take one or more ECG readings and transmit them to the screening service as the baseline information 224.

The customer then signs and sends the Agreement to Participate to the screening service 240. Otherwise, if the Agreement to Participate 241 has not been received, the customer is reminded 242 to send in the Agreement. Before the enrollment process can be completed however, the customer's physician must provide his completed forms to the selling entity or the screening service. If the physician's forms have not been received 243, reminder are sent to the customer and physician 244. If the Agreement to Participate and the physician's forms have been received, enrollment is complete 270. If necessary, the customer or their physician may be called by phone, sent a fax or electronic mail, or mailed a reminder to return his form 242 and 244.

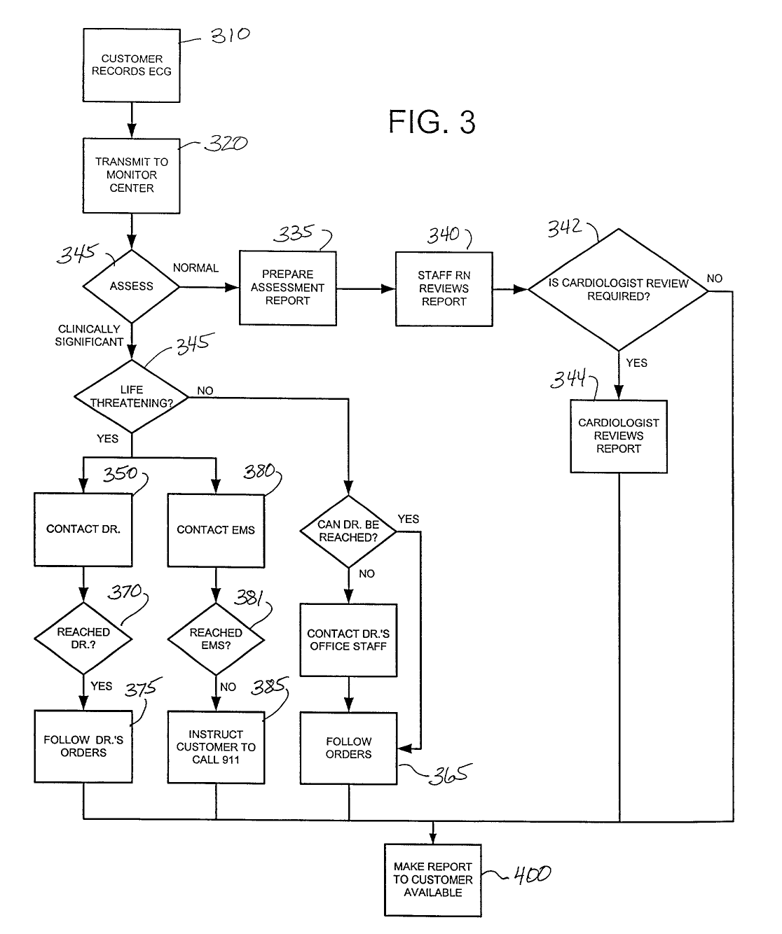

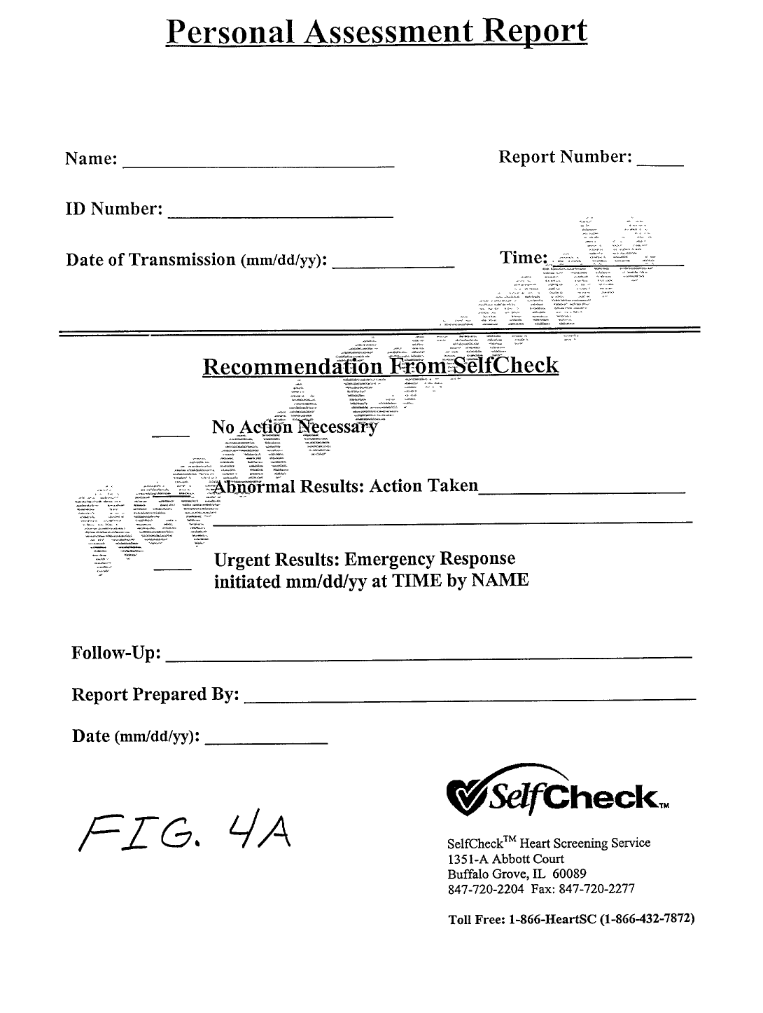

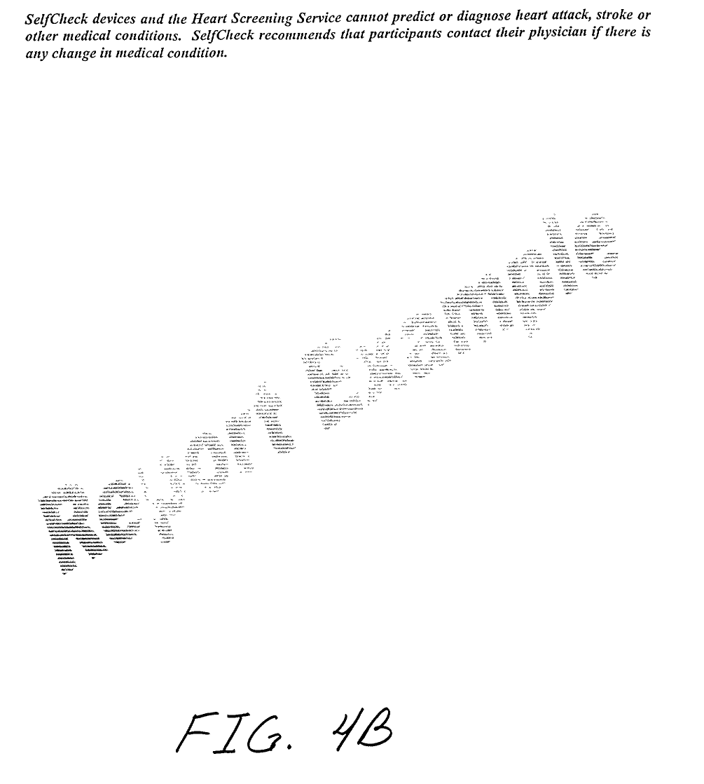

FIG. 3 depicts the data collection 310 and transmission 320 by the customer, the screening and assessment of the customer's data, and the creation of a report based upon that data. Because the data potentially can indicate a clinically significant or life threatening event, potential activities at the screening center also relate to efforts to ensure that the customer receives adequate medical care if, in fact, his condition is not normal. In the case of a preferred cardiac event recorder, the screening function begins when the customer records a thirty second ECG rhythm strip that he would like to transmit 310. Then he calls the screening center. At the screening center, preferably a trained cardiac technician or registered cardiac nurse will answer the phone and verify the caller's identity. This verification may involve a unique password or ID number, or more secure or advanced means to verify identity. He will also ask the customer a few brief questions about the customer's symptoms and the recorded event to better understand the customer's present medical status. The customer will then be asked to transmit the ECG rhythm strip according to the cardiac event recorder instructions 320. If necessary, the answering technician will assist the customer so that the transmission procedure is repeated or properly accomplished.

The transmission is received on software that is known by those in the art. An example of that software is PaceArt® 2000 arrhythmia monitoring program, which is commercially available and presently used by LifeWatch. The cardiovascular technician is responsible for entering data supplied by the customer and also is responsible for generating an assessment report 335. Once the ECG rhythm strip is received, and while the customer is still on the phone, the technician assesses whether or not the customer's rhythm strip presents any clinically significant symptoms 345. During the customer's phone call, the cardiac technician may call upon nurses or doctors that the technician can consult with in assessing the customer's condition.

In the case of cardiac recorders made, distributed, and planned to be distributed by Instromedix, (Card Guard Technologies), the specifics of the present method are easy for both the customer and the screening center. The cardiac event recorder may have four button-shaped feet on its back that are the leads that pick up the customer's heart signal. Thus, the customer simply places the cardiac event recorder on his chest, and the card digitally records a thirty-second period of the customer's heart signal. Alternatively, the cardiac event recorder can be set up so that wire leads can connect to small self-adhesive patches and electronically conducting gel placed on the customer's chest. When the customer sends his thirty second ECG to the screening center 320, the cardiac event recorder converts the digital signal to the analog FM signal that is sent trans-telephonically to the center. The center's receiver is preferably analog to digital, so that the data can immediately be converted and stored on a computer. Preferably, the data is transmitted using a proprietary encryption protocol unique to both the screening center and the recording device. In that way, the entity providing screening services may use a patented or proprietary recording device that other services cannot. The providing entity may than have better control over the quality of devices working with its service so that customers do not obtain low quality devices from other manufacturers and believe that the service is responsible for any less desirable results. Alternatively, the entity providing the screening service could sell or license its recording device or device technology to others for additional revenue.

Typically, the customer's data is stored on a computer hard drive, together with older data, baseline data, and possibly other information. Based upon a predetermined policy, the screening center may periodically archive data on disk or tape. Alternatively, the customer may be part of an agreement as to the timing of the storage and archiving of old data.

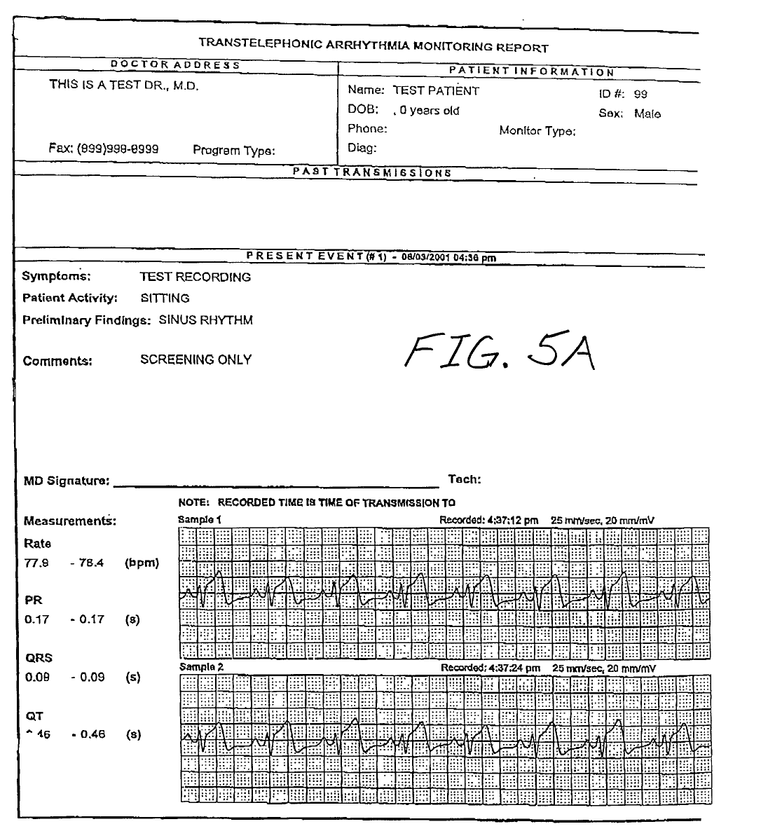

If there are not any clinically significant symptoms, the final assessment report is completed by the technician 335 and reviewed by a staff registered nurse 340 within a limited period of time, such as twenty-four hours. If the registered nurse requests 342, a staff cardiologist present at or accessible to the screening center is consulted for further interpretation 344. If necessary, the registered nurse or cardiologist will then request that the customer be phoned and instructed to contact his physician as soon as possible. A sample of such a report is shown in FIG. 4. Other reports may be used, including those that actually provide a traditional ECG readout. Regardless of the outcome of the assessment by the screening center, the customer will have access to the assessment report 400 through either the Internet, facsimile, electronic mail or mail, as arranged between the customer and the entity selling the screening service.

A novel feature of the present invention is that the screening service and its assessment are available directly to the customer and not through a physician. In the past, such services were either only provided to a physician by a company such as LifeWatch; or were made available to patients and conducted directly by the doctor's office practice, who in turn decided whether to provide the assessment results to the patient. Ordinarily, a patient's physician would prescribe the service. In the present invention, the service is performed at the request of, and the assessment report provided directly to, the customer. The customer reserves the option of providing the report to his own physician. Depending upon the attitude of insurance companies and Medicare, the customer may be able to obtain a prescription for the screening service, so that he need not pay for it out of pocket. It is one aspect of the invention, however, that the customer himself enrolls directly in the screening service and receives the report directly from the service. He also owns the recording device.

During enrollment, the customer will decide the form in which he receives the report. He may decide to receive it in one, two, or more different forms as previously noted. The number and ways in which the customer receives the reports may or may not affect the price the customer pays. The preferred form of providing a report to the customer is by use of the Internet. When the customer enrolls, he is given a personal identification number (“PIN”). When he wishes to view a report, he accesses a predesignated Internet site, enters his PIN, and obtains the report. The Internet site may also permit the customer to access previous reports, regardless of whether the customer has recently sent in data for an assessment. Alternatively, one could place an additional level of security into the process of accessing the report by only making the information available for a fixed period of time after the report has been generated.

One particular advantage of placing the report on the Internet is that a customer's personal physician could have easy access to the report. All the physician would need would be the customer's PIN, or any other information required for site security. The physician, like the customer, could view the report on screen. He could also download the report from the Internet, storing or printing the report, or both. If desired, the screening service may set up its Internet site to monitor the number of times each customer's data accessed, and whether such access has been by the customer or by the physician.

A desirable feature of the preferred version of this method for heart screening is that the assessment occurs entirely without the assistance of a physician. In other words, while medically related services are provided to the customer, the practice of medicine by a physician does not actually occur during the provision of those services. The physician provides education and some quality control to the technicians and nurses who actually perform the assessment. If it is necessary for the screening center personnel to consult with a physician about a specific customer's data, the preferred version of this method of screening is that the customer does not incur additional costs because of the use of a physician. In other words, the price agreed to by the customer never changes, regardless of whether a physician becomes involved in providing an assessment of the customer's condition. Moreover, there is no communication between the customer and the physician associated with the screening center.

It is likely that from time to time the screening service will encounter an emergency situation, in which the customer presents data that indicates the occurrence of a clinically significant or life threatening event 345, up to and including a heart attack or potentially lethal dysrhythmia. The present method requires notification for all clinically significant and life threatening events, such as high-rate ventricular tachycardia arrhythmia and other serious cardiac events. Once the determination of a problematic assessment occurs, the customer is either called by the screening center, or kept on the phone if the customer has remained on the phone since providing the ECG data. The customer symptoms should be reviewed and the customer may then be instructed to perform a follow-up ECG reading and transmission, after which that information is also assessed at the screening center.

Once the screening center has ascertained that a clinically significant or life threatening event has occurred, someone from the screening center calls the customer's physician to obtain instructions 350. In life threatening situations in particular, such as high-rate ventricular tachycardias, the screening center will attempt to contact the doctor 350 who has left his contact numbers with the screening center. Such a personal doctor is capable of recognizing the severity of the situation. If the customer's physician is reached 370, the physician can provide orders to be followed by the customer 375. An emergency medical system that is local to the customer and can respond immediately is also contacted 380. The technician or registered nurse on the telephone with the customer will ascertain whether the customer is not alone and is accompanied by a person competent to assist the customer.

Ideally, the disclosed method of screening also includes, in emergency situations, an emergency medical service (“EMS”) system that is local to the customer for use in contacting emergency medical technicians who will travel to and assist the customer 380. Such EMS systems are known in the art. If the screening service cannot activate the EMS 381, then it should instruct the customer or the individual accompanying the customer to hang up and call nine-one-one (“911”) or the local emergency response telephone number 385. The technician or registered nurse from the screening center may call the customer back shortly thereafter to ensure that emergency medical treatment is forthcoming. Moreover, someone from the screening center may remain on the phone with the customer while the screening center continues to attempt to contact the customer's physician.

If a life threatening event has not occurred, the screening center will attempt to contact the physician 355. If the customer's physician is not available 355, personnel from the physician's office may be contacted 360. The customer should then follow the orders provided by either the physician or someone from the physician's office 365.

In the event that a customer's assessment is deemed normal by the cardiovascular technician and reviewing nurse, a report is then provided to the customer 400. If the assessment has resulted in a clinically significant or life threatening event, then the report is edited to reflect the conduct of the screening center in providing an emergency notification. In all cases, a report is made available to the customer 400.

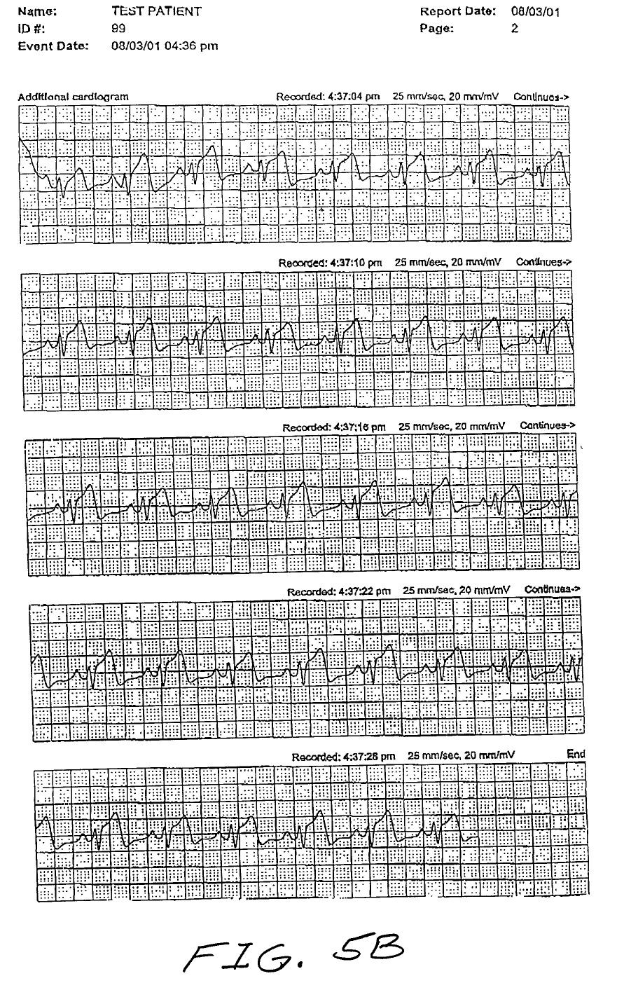

Further, if a life threatening event has occurred, the customer's personal doctor may desire to study the customer's ECG stored by the screening center. To respond to such an event, the screening center can prepare a doctor's report such as that shown in FIG. 5 to be furnished to the customer's doctor. As part of the enrollment, the customer indicated to the screening center that the customer agreed that the screening center may provide such reports if requested by the customer's personal doctor. The customer may also have indicated that the screening center can provide such reports, other reports, or other information to other persons, such as additional doctors the customer may have. For example, the customer may have a personal doctor and a cardiologist, both of whom may desire to have a copy of the report shown in FIG. 5. As also shown, the report of FIG. 5 contains the customer's ECG data is strip chart format with surrounding information, such as the date and time of receipt of the ECG from the customer. Other reports with other information may be provided as desired.

While embodiments of the invention have been illustrated and described, it will be apparent that various modifications can be made without departing from the spirit and scope of the invention. For example, the functions described in the method can be performed by several different business entities that are or are not related. As an example, the business that manufactures the recording device is related to the business that provides the screening service. They may each be an operating division of the same company, a subsidiary of a parent company that controls both, or one may be the subsidiary of the other. In the case of direct mail or telemarketing sales, an unrelated company may be hired to sell the recording device to the customer. The same selling entity, unrelated to the device manufacturer or the screening service, may provide the entire enrollment function, including providing answers to detailed questions about the entire service, from recording device to customer assessment report. Alternatively, the screening center may include personnel who perform some or all of the enrollment process.

If the recording device is sold through a retail outlet, the manufacturer may sell the device through in-house salesmen or third party sales representatives, with drop shipments made from the factory or inventory centers to the retail outlet. Still other known structures of business relationships may be used in setting up the present invention. For example, more than one screening center can be established, with all of the centers having a single accessible database. Each center may be a division or operating entity of a single corporation, or each center may a separate corporation affiliated with a parent or other related entity.

The method is also applicable to screening other health problems, such as pulmonary conditions or diabetes. In cases where the recording device and services would be covered by insurance, the customer may obtain a prescription. The purchase of the device, however, is still made by the customer at a retail or direct sales level, and not from a physician and preferably not from a medical supply company. Occasionally, extraordinary circumstances may generate other, foreseeable modifications. For example, a customer may purchase a cardiac event recorder from a retail outlet with the intent of enrolling in the screening service, but before he can enroll, he experiences palpitations. The customer may actually end up providing data to the screening center and receiving a report before he has formally enrolled in the screening service. Alternatively, the customer may choose not to enroll for a substantial period of time, but instead enrolls in the service by paying one time for a single assessment. Accordingly, it is not intended that the invention be limited, except as by the appended claims.

What is claimed is:

1. A method of providing a medical screening service to a customer, comprising:
arranging to make available a medical recording device to a customer, the recording device collecting electronic medical data about the customer;
arranging to provide to the customer a screening service that assesses the electronic medical data collected from the customer by the recording device, the screening service comprising:
receiving at a remote screening center the electronic medical data of the customer collected by the medical recording device, the data having been electronically transferred to the screening center for assessment;
assessing the medical data of the customer at the screening center and producing assessment results;
creating a customer assessment report representative of the assessment results of the medical data of the customer; and
making available the customer assessment report directly to the customer.

2. The method of claim 1 wherein the step of arranging to make available a medical recording device comprises selling the recording device to the customer through a direct mail arrangement.

3. The method of claim 1 wherein the step of arranging to make available a medical recording device comprises selling the recording device to the customer through a telemarketing arrangement.

4. The method of claim 1 wherein the step of assessing the medical data of the customer at the screening center and producing assessment results comprises the step of assessing the data by trained medical personnel other than a doctor that the customer has directly engaged.

5. The method of claim 1 wherein the step of arranging to provide the customer a screening service comprises the step of charging the customer a fee, the amount of which is based on the level of service selected by the customer.

6. The method of claim 5 wherein the step of charging the customer a fee comprises the step of basing the fee amount on the number of times electronic medical data of the customer collected by the medical recording device is received at a remote screening center for assessment.

7. The method of claim 1 wherein the step of making available the customer assessment report directly to the customer comprises at least one of the steps of:
sending the report to the customer via facsimile transmission;
sending the report to the customer through a mail delivery service;
sending the report to the customer via electronic mail; and
posting the report on an Internet-accessible computer that is adapted for viewing by the customer.

8. The method of claim 7 wherein the step of posting the report on an Internet-accessible computer comprises posting the report so that the customer can download a copy of the report either electronically or as a printed document or both.

9. The method of claim 8 further comprising:
selecting by the customer the mode of communication of the report to the customer.

10. The method of claim 1 wherein the step of arranging to make available a medical recording device comprises making available a device that records ECG data from the customer and which is adapted to transmit the recorded ECG data to the screening center.

11. The method of claim 10 wherein the step of arranging to make available a device that records the customer's ECG data comprises making available a portable recording device having at least two leads for application to the customer and a recorder function in which at least five seconds of ECG data may be recorded by the recording device.

12. The method of claim 11 wherein the step of making available a portable device that records the customer's ECG data comprises making available a portable recording device that is adapted to transmit the recorded data over a telephone line to the screening center.

13. The method of claim 1 wherein the step of assessing the medical data of the customer at the screening center comprises assessing the data by a doctor who has been retained by the screening center to assess customer data as selected by the screening center and who has not been retained directly by the customer.

14. The method of claim 13 wherein the step of assessing the medical data by a doctor comprises the step of assessing ECG data from the customer by a cardiologist.

15. The method of claim 14 further comprising the step of charging the customer a fee for the screening services, the amount of which remains the same even if the cardiologist assesses the customer's ECG data.

16. The method of claim 1 further comprising the step of requesting for the customer emergency medical care that is local to the customer if the step of assessing the medical data of the customer at the screening center indicates that the customer has experienced a life threatening event.

17. The method of claim 1 further comprising the step of obtaining an agreement by a personal doctor of the customer under which the personal doctor agrees to furnish the screening center with a telephone number of the personal doctor or doctor's practice and the personal doctor of the customer agrees to take telephone calls or other messages from the screening service in the event of a significant clinical finding.

18. The method of claim 18 wherein the screening service automatically provides the assessment report to the personal doctor when there is a significant clinical finding.

19. The method of claim 1 wherein the step of assessing the medical data of the customer at the screening center comprises assessing the data by a cardiovascular technician and review of the data by a registered nurse.

20. The method of claim 9 further comprising:
monitoring by the screening center the identifications of those who access the Internet report and how many times the report has been accessed.

21. A method of providing a heart screening service to a customer, comprising:
arranging to make available for direct sale to a customer an electronic, heart recording device, and the recording device collecting electronic ECG data about the customer;
arranging to provide the customer a screening service that provides a fee-for-service assessment of the electronic ECG data collected by the recording device, the screening service including the steps of:
receiving at a remote screening center the electronic ECG data of the customer collected by the heart recording device, the customer having transferred the data to the screening center for assessment;
assessing the ECG data of the customer at the screening center and producing assessment results without the viewing of the customer's ECG data by a personal doctor of the customer;
creating a customer assessment report at the screening center representative of the assessment results of the ECG data of the customer; and
making available the customer assessment report directly to the customer.

22. The method of claim 21 wherein the step of making available the customer assessment report directly to the customer comprises at least on of the steps of:
sending the report to the customer via facsimile transmission;
sending the report to the customer through a mail delivery service;
sending the report to the customer through electronic mail; and
posting the report on an Internet-accessible computer and which is adapted for printing by the customer.

23. The method of claim 22 further comprising:
selecting by the customer the mode of communication of the report to the customer.

24. The method of claim 22 wherein the step of arranging to provide the customer a screening service comprises the step of charging the customer a fee, the amount of which is based on the level of service selected by the customer.

25. The method of claim 24 wherein the step of charging the customer a fee comprises the step of basing the fee amount on the number of times electronic medical data of the customer collected by the medical recording device is received at a remote screening center for assessment.

26. The method of claim 22 further comprising:
monitoring by the screening center the identifications of those who access the Internet report and how many times the report has been accessed.

27. The method of claim 22 further comprising:
obtaining the agreement by a personal doctor of the customer to receive communications from the screening center in the event of a significant clinical finding.

28. The method of claim 27 wherein the screening service automatically provides the assessment report to the personal doctor when there is a significant clinical finding.

29. A method providing a medical screening service to a customer, comprising:
arranging for the sale of an electronic medical recording device directly to a customer, the recording device collecting electronic medical data about the customer;
arranging to provide the customer a screening service that provides a fee-for-service assessment of electronic medical data collected from the customer by the recording device;
receiving at a remote screening center the electronic medical data of the customer collected by the medical recording device, the data having been electronically transferred by the customer to the screening center for assessment;
assessing the medical data of the customer at the screening center and producing assessment results;
creating a customer assessment report at the screening center representative of the assessment results of the medical data of the customer;
making available the customer assessment report directly to the customer;
requesting emergency medical care for the customer if the step of assessing the medical data of the customer at the screening center indicates that the customer has experienced a clinically significant event; and
automatically sending the assessment report to a personal doctor of the customer.

30. The method of claim 29 wherein the step of assessing the medical data from the customer comprises assessing the data by a registered nurse.

31. The method of claim 29 wherein the transfer of the data from the recording device to the screening center is performed by using a proprietary encryption protocol.

32. The method of claim 29 further comprising:
making the report available through Internet access; and
monitoring by the screening center the identifications of those who access the Internet report and how many times the report has been accessed.
